(19) United States
(12) Patent Application Publication
(10) Pub. No.: US 2024/0255091 A1
(43) Pub. Date: Aug. 1, 2024

(54) LINER ARRANGEMENT FOR INSERTING IN A PIPE STRUCTURE, AND METHOD FOR RELINING A PIPE STRUCTURE

(71) Applicant: REPIPER AB, Mölndal (SE)

(72) Inventor: Jesper STOCKFORS, Märsta (SE)

(21) Appl. No.: 18/561,117

(22) PCT Filed: May 19, 2022
(86) PCT No.: PCT/SE2022/050495

§ 371 Date: Nov. 15, 2023

(30) Foreign Application Priority Data
May 19, 2021 (AU) 2021901501

(51) Int. Cl. F16L 55/165; F16L 55/179

(52) U.S. Cl. CPC F16L 55/1654; F16L 55/179

(57) ABSTRACT

This relates to a liner arrangement for inserting in a pipe structure, the liner arrangement includes one liner part, inserting tool including inserting hose and units for deflation and inflation, and a fastener, wherein the one liner part has a length and is adapted to cooperate with the unit for deflation and inflation, wherein a partitioning of the one liner part encloses a part, of the inserting hose, and the partitioning has a length, wherein a fraction of the enclosing partitioning, together with the fastener, enable fastening of the one liner part to the inserting hose during insertion of the liner arrangement, and the liner arrangement has ability to bend and thereby demonstrating a minimum outside bend radius not greater than about the smallest inside bend radius of the pipe structure; and method for relining a pipe structure.

### TECHNICAL FIELD

The present invention relates to a liner arrangement for inserting in a pipe structure and to a method for relining a pipe using the liner arrangement, wherein the liner arrangement has ability to bend and thereby demonstrating a minimum outside bend radius not greater than about the smallest inside bend radius of said pipe structure, and wherein the liner arrangement, and the method for relining, are suitable in a context of pipe structures comprising narrow bends, i.e. comprising rather small bend radiuses, such as when comprising pipe constructions such as boundary traps.

### BACKGROUND ART

In areas comprising pipe structures such as, e.g. sewer systems for transporting fluids in houses, offices and other buildings, it is known to renovate damaged, or worn out, sewage pipes by means of relining processes. During such processes, a pipe can be provided with a new internal liner material, and there will be no need to replace the damaged, or worn out, part of the pipe. Such a relining process may be carried out in generally all types of circumstances having a pipe structure for removing fluids and sewage to a sewer system or similar.

In WO 2020/197477 there is disclosed a liner arrangement for installation in a pipe structure, comprising at least one liner part and a sealing arrangement, wherein the liner arrangement is configured to cooperate with an inflatable bladder such that when the liner part and the inflatable bladder are located at a desired position and the bladder is inflated, the liner part will deploy or expand so that it conforms to the interior shape of the pipe structure.

Further, in EP 2499414 B1 there is described an apparatus for installing a liner in a pipe including pipe bends, wherein the apparatus comprises a proximal collar fitting and a distal collar fitting interconnected by a small cross-sectional area flexible tube or rod, an inflatable bladder, one end of the inflatable bladder being secured to the proximal collar fitting and the other end of the inflatable bladder being secured to the distal collar fitting with the small diameter flexible tube or rod disposed inside the interior of the inflatable bladder. The apparatus also comprises a push-pull-turn hose with a proximal end and a distal end, said distal end of said a push-pull-turn hose being connected in a releasable way to the proximal collar fitting.

However, there is still a need for further improved liner arrangements for installation in pipe structures, and especially a need for liner arrangements enabling passages, i.e. installations through very narrow bends in such pipe structures.

### DESCRIPTION OF THE INVENTION

The present invention relates to a liner arrangement for inserting in a pipe structure, wherein the liner arrangement comprises at least one liner part, an inserting tool comprising an inserting hose and means for deflation and inflation, and fastening means, wherein the at least one liner part has a length (l1) and is adapted to cooperate with the means for deflation and inflation, wherein a partitioning of said at least one liner part encloses a part (x), of said inserting hose, and said partitioning has a length (l2), wherein at least a fraction (y) of the enclosing partitioning, together with the fastening means, enable fastening of the at least one liner part to said inserting hose during insertion of the liner arrangement in a pipe structure, and wherein, while the at least one liner part is fastened to said inserting hose, and during said insertion, the liner arrangement has ability to bend and thereby demonstrating a minimum outside bend radius not greater than about the smallest inside bend radius of said pipe structure.

In accordance with the present invention, the liner arrangement, as described herein, comprises at least one liner part, wherein the at least one liner part has a length (l1) and is adapted to cooperate with the means for deflation and inflation.

Further, the liner arrangement also comprises an inserting tool, wherein the inserting tool comprises an inserting hose and means for deflation and inflation.

Furthermore, in accordance with the present invention, the inserting hose, e.g. the push-pull-turn hose, is in fluidic connection with the means for deflation and inflation.

In accordance with the present invention, the liner arrangement, as described herein, comprises fastening means, wherein the fastening means helps enabling fastening of the at least one liner part to said inserting hose.

Moreover, in accordance with the present invention, a partitioning of said at least one liner part encloses a part (x), of said inserting hose, and said partitioning has a length (l2), wherein at least a fraction (y) of the enclosing partitioning, together with the fastening means, enable fastening of the at least one liner part to said inserting hose during insertion of the liner arrangement in a pipe structure.

In embodiments of the present invention, the length (l2) of said partitioning stretches mainly in the same direction as length (l1) of the at least one liner part.

Still further embodiments of the present invention disclose a liner arrangement, as described herein, wherein the liner arrangement comprises, at least, a second further liner part, besides said “first” at least one liner part.

Even further embodiments of the present invention disclose a liner arrangement, as described herein, wherein the liner arrangement comprises, at least, a second further liner part, besides said “first” at least one liner part, wherein said “first” at least one liner part has the length (l1), and wherein the length (l2) of the partitioning stretches mainly in the same direction as the length (l1) of said “first” at least one liner part.

Further, in accordance with embodiments of the present invention, the fastening means, as described herein, may, for example, comprise glue, tape, band, e.g. rubber band, and/or clamps, e.g. glue, band and/or tape. Furthermore, the fastening means helps enabling fastening of the at least one liner part to said inserting hose during insertion of the liner arrangement in a pipe structure.

Even further embodiments of the present invention disclose a liner arrangement, as described herein, wherein the liner arrangement comprises, at least, a second further liner part, e.g., a second further liner part, besides said at least one liner part, and wherein the liner parts, of the liner arrangement, together form mainly a T-shape, for example, at least two liner parts, of the liner arrangement, are connected to each other and together mainly have, e.g., a T-shape form.

According to further embodiments, the liner part/s of the liner arrangement, as described herein, has/have each, individually, for example, a general tube-shape which e.g. is/are each, individually, cylindrical.

In embodiments of the present invention, the liner arrangement comprises at least one liner part, wherein said at least one liner part is adapted to be curable.

In embodiments of the present invention, the liner arrangement comprises at least one liner part, wherein said at least one liner part is adapted with a curable composition, for example, said at least one liner part is adapted with a curable composition extending around the outer surface of said at least one liner part.

In embodiments of the present invention, the liner arrangement comprises at least one liner part, wherein said at least one liner part is adapted to be impregnated with a curable composition, e.g. a suitable curable resin.

Further embodiments of the present invention disclose a liner arrangement, as described herein, wherein said at least one liner part is, for example, made from woven, or unwoven felt, being impregnated with a suitable curable resin.

In further embodiments of the present invention, said at least one liner part may, for example, comprise a thermosetting plastic material, e.g. polyester, glass fiber, Kevlar and/or carbon fiber, or e.g. be made of a thermosetting plastic material, e.g. polyester, glass fiber, Kevlar and/or carbon fiber.

In even further embodiments of the present invention, said at least one liner part may, for example, comprise a thermosetting plastic material, e.g. polyester, or e.g. is made of a thermosetting plastic material, e.g. polyester, for example, polyester felt.

Curing may be achieved, in accordance with the present invention, by means of hot fluid, for example, oil, water or gas, e.g. steam and/or hot air, for example pressurized fluid e.g. pressurized steam, pressurized gas and/or pressurized air.

In even further embodiments of the present invention, said at least one liner part being adapted to be curable, being adapted with a curable composition, and/or comprising a curable resin, may each be of a self-curing type and/or be curable by increased temperature, e.g. may be curable by increased temperature.

In accordance with embodiments of the present invention, the inserting hose, as described herein, may, for example, be a, so called, push-pull-turn hose. The inserting hose, e.g. the push-pull-turn hose, is flexible, as well as, and enables pushing, and positioning, of the liner arrangement. The flexibility of the inserting hose, e.g. the push-pull-turn hose, allows the inserting hose to pass through narrow and bended pipe and its stability allows it to transmit sufficient push- and rotation force to the liner arrangement.

Further, the liner part/s of the liner arrangement, as described herein, is/are adapted to cooperate with the means for deflation and inflation.

Furthermore, said enclosing of the inserting hose, by said partitioning, of said at least one liner part, having a length (l2), together with the fastening means, enable fastening of the at least one liner part to said inserting hose, especially during the insertion of the liner arrangement in a pipe structure, as well as, during the installation of the liner arrangement in a pipe structure.

In accordance with embodiments of the present invention, the length (l2) of said partitioning corresponds to approximately 0.9 to 1.1 of the length (l1) of said at least one liner part, e.g. the length (l2) of said partitioning corresponds to approximately the length (l1) of said at least one liner part.

In accordance with further embodiments of the present invention, the “at least a fraction (y)” may be one, two, three, four or more, fractions (y) of the enclosing partitioning.

Further, when the “at least a fraction (y)” comprises two, three, four or more, fractions (y), for example two, three or four, fractions (y), e.g. two or three, fractions (y), said fractions (y) are fractions of said partitioning.

In accordance with an embodiment of the present invention, the “at least a fraction (y)” comprises two fractions (y) being fractions of said partitioning.

In a further embodiment of the present invention, the “at least a fraction (y)” comprises three fractions (y) being fractions of said partitioning.

In accordance with further embodiments of the present invention, said enclosing of the inserting hose, by said partitioning, of said at least one liner part, having a length (l2), together with the fastening means, as well as, together with the means for deflation and inflation, enable fastening of the at least one liner part to said inserting hose, especially during the insertion of the liner arrangement in a pipe structure.

Here, said enclosing of the inserting hose, by said partitioning, of said at least one liner part, having a length (l2), together with the means for deflation and inflation, enable, and may improve, said fastening of the at least one liner part to said inserting hose, by utilizing especially the deflation function of the means for deflation and inflation.

Furthermore, in accordance with the present invention, an effective fluid connection between the inserting hose, the means for deflation and inflation, and said at least one liner part, is also ensured.

In accordance with embodiments of the present invention, the means for deflation and inflation, as described herein, may comprise fluid, e.g. hot fluid, injecting means; fluid withdrawing means, e.g. a source for providing vacuum; and a deflatable and inflatable bladder; and/or said at least one, and said second further, liner parts, also functioning themselves as a deflatable and inflatable bladder.

Still further embodiments of the present invention include a liner arrangement, as described herein, wherein the at least one liner part comprises hole/s for letting fluid pass, or the wherein second further liner part, when present, comprises hole/s for letting fluid pass.

Furthermore, in accordance with the present invention, during an insertion of the liner arrangement, the liner arrangement has the ability to bend and thereby demonstrating a minimum outside bend radius not greater than about the smallest inside bend radius of said pipe structure.

The fact that the liner arrangement, as described herein, is designed to not have hard edges like fittings and/or clamps, will reduce the risk of getting stuck inside the pipe structure significantly.

Further, the liner arrangement in accordance with the present invention enables a design without hard edges like fittings and/or clamps, and further also without hard metal fittings. Furthermore, since there are no hard metal fittings, maneuvering the liner arrangement, as described herein, inside a pipe structure will not lead to any unnecessary scratching and/or tearing on the existing pipe structure.

The liner arrangement, as described herein and in accordance with the present invention, has because of the features:
that a partitioning of said at least one liner part encloses said part (x) of said inserting hose,
that said at least a fraction (y) of the enclosing partitioning of said at least one liner part, together with the fastening means, enable fastening of the at least one liner part to said inserting hose during insertion of the liner arrangement in a pipe structure, and
that, while the at least one liner part is fastened to said inserting hose, and during said insertion, the liner arrangement has an ability to bend and thereby demonstrating a minimum outside bend radius not greater than about the smallest inside bend radius of said pipe structure;
   a such an ingenious and slick design, never seen before, that will make insertions, and also installs, of a liner arrangement possible through pipe constellations, i.e. pipe structures, never before possible, e.g. through pipe constellations comprising for example, pipe constructions such as boundary traps. The fact that the liner arrangement, as described herein, is designed to not have hard edges like fittings and/or clamps, will reduce risk of getting stuck inside the pipe structure significantly. Thus, the liner arrangement, in accordance with the present invention, has the potential to save a lot of infrastructure, and work, since digging may be avoided, and road assistance may be reduced when relining projects are carried out.

Further, the liner arrangement, in accordance with the present invention, enables a design without hard edges like fittings and/or clamps, and further also without hard metal fittings. Furthermore, since there is no hard metal fittings, maneuvering the liner arrangement, as described herein, inside a pipe structure will not lead to any unnecessary scratching and/or tearing on the existing pipe structure. Further, there will also be plenty of inside pipe structure room left besides the liner arrangement, to also have an inspection camera next to the liner arrangement in the pipe structure, which would enable getting good view during operation, e.g. insertion, installation and/or relining.

The liner arrangement, in accordance with the present invention, has surprisingly been shown to be especially useful in pipe structure systems where the only access point to a target pipe structure is located on the outside, e.g. on the outside of a building, or similar. In further embodiments, in accordance with the present invention, a liner arrangement, as described herein, is disclosed, wherein the partitioning of said at least one liner part encloses a part (x) of said inserting hose, wherein at least a fraction (y) of the enclosing partitioning, together with the fastening means, enable fastening of the at least one liner part to said inserting hose during insertion of the liner arrangement in a pipe structure, and said enclosing also helps enabling the cooperation of the at least one liner part with the means for deflation and inflation.

In still further embodiments, in accordance with the present invention, a liner arrangement, as described herein, is disclosed, wherein the partitioning of said at least one liner part encloses a part (x) of said inserting hose, wherein said “at least a fraction (y)” comprises one, two, three, four or more, fractions (y) of the enclosing partitioning, and wherein the “at least a fraction (y)”, the fastening means, and the deflation function, of the means for deflation and inflation, together enable fastening of the at least one liner part to said inserting hose during insertion of the liner arrangement in a pipe structure.

In accordance with further embodiments of the present invention, a liner arrangement, as described herein, is disclosed, wherein the partitioning of said at least one liner part encloses a part (x) of said inserting hose, wherein said “at least a fraction (y)” comprises one, two or three fractions (y), e.g. one fraction (y), for example two or three fractions (y), of the enclosing partitioning, and wherein the “at least a fraction (y)”, the fastening means, and the deflation function, of the means for deflation and inflation, together enable fastening of the at least one liner part to said inserting hose during insertion of the liner arrangement in a pipe structure, and said enclosing also helps enabling the cooperation of the at least one liner part with the means for deflation and inflation, during installation of the liner arrangement in a pipe structure.

In even further embodiments, in accordance with the present invention, a liner arrangement, as described herein, is disclosed, wherein the partitioning of said at least one liner part encloses a part (x) of said inserting hose, wherein said “at least a fraction (y)” comprises two fractions (y), of the enclosing partitioning, and wherein the “at least a fraction (y)”, the fastening means, and the deflation function, of the means for deflation and inflation, together enable fastening of the at least one liner part to said inserting hose during insertion of the liner arrangement in a pipe structure, and said enclosing also helps enabling the cooperation of the at least one liner part with the means for deflation and inflation, during installation of the liner arrangement in a pipe structure.

In embodiments, in accordance with the present invention, a liner arrangement, as described herein, is disclosed, wherein the liner arrangement is mainly soft, e.g. the liner arrangement comprises mainly soft connections, e.g. soft couplings.

In further embodiments, in accordance with the present invention, a liner arrangement, as described herein, is disclosed, wherein a segment of the liner arrangement intended to pass the smallest inside bend radius of said pipe structure, during said insertion, has the ability to bend and thereby demonstrating a minimum outside bend radius not greater than about the smallest inside bend radius of said pipe structure.

In still further embodiments, in accordance with the present invention, a liner arrangement, as described herein, is disclosed, wherein the liner arrangement has an ability to bend and ability to demonstrate said minimum outside bend radius, as described herein, over, at least, a main stretch of the liner arrangement, wherein the main stretch stretches or extends from the leading end of the liner arrangement, over, and past, the length (l1) of the at least one liner part, to an area on the inserting hose, e.g. an area on the inserting hose being in proximity to said at least one liner part.

In further embodiments, in accordance with the present invention, a liner arrangement, as described herein, is disclosed, wherein the liner arrangement has an ability to bend and thereby demonstrating an outside bend radius not greater than the smallest inside bend radius of said pipe structure being about 150 mm, e.g. not greater than about 97% of the smallest inside bend radius of said pipe structure, for example, being about 150 mm.

In embodiments, in accordance with the present invention, a liner arrangement, as described herein, is disclosed, wherein the at least one liner part, during said insertion, cooperates with the means for deflation and inflation, and thereby the at least one liner part obtains an inflated state.

In further embodiments, in accordance with the present invention, a liner arrangement, as described herein, is disclosed, wherein the liner arrangement has ability to bend and thereby demonstrating a minimum outside bend radius not greater than about 97% of the smallest inside bend radius of said pipe structure.

In still further embodiments, in accordance with the present invention, a liner arrangement, as described herein, is disclosed, wherein the liner arrangement, together with said fastening means, has an outer diameter that is smaller than the inner diameter of said pipe structure.

In even further embodiments, in accordance with the present invention, a liner arrangement, as described herein, is disclosed, wherein the liner arrangement has ability to bend and thereby demonstrating a minimum outside bend radius not greater than the smallest inside bend radius, of said pipe structure, being about 150 mm, e.g. not greater than about 97% of the smallest inside bend radius, of said pipe structure, being about 150 mm.

In further embodiments of the present invention, it is disclosed a liner arrangement, as described herein, wherein the liner arrangement demonstrates a minimum outside bend radius not greater than about 95%, e.g. 93%, for example 90%, of the smallest inside bend radius of said pipe structure.

In still further embodiments of the present invention, it is disclosed a liner arrangement, as described herein, wherein the liner arrangement has ability to bend and thereby demonstrating a minimum outside bend radius not greater than about 100 mm, e.g. not greater than about 75 mm, for example, not greater than about 51 mm.

In even further embodiments of the present invention, it is disclosed a liner arrangement, as described herein, wherein the liner arrangement, together with said fastening means, has an outer diameter not greater than about 90% of the smallest inside bend radius of said pipe structure.

In an embodiment, in accordance with the present invention, a liner arrangement, as described herein, is disclosed, wherein the at least one liner part comprises a curable composition, e.g. is adapted to be impregnated with a curable resin, the liner arrangement further comprises a sealing arrangement extending along the circumference of the at least one liner part, and the sealing arrangement is pre-mounted on at least one end section of the least one liner part before inserting the liner arrangement in said pipe structure.

In further embodiments, in accordance with the present invention, a liner arrangement, as described herein, is disclosed, wherein the means for deflation and inflation comprises fluid, e.g. hot fluid, injecting means, for example, oil, water or gas, e.g. steam and/or air, e.g. hot air, injecting means, for example pressurized fluid e.g. pressurized steam, pressurized gas and/or pressurized air, e.g. pressurized hot air, injecting means; fluid withdrawing means, e.g. a source for providing vacuum; and a deflatable and inflatable bladder and/or said at least one liner part also functioning itself as a deflatable and inflatable bladder.

In even further embodiments, in accordance with the present invention, a liner arrangement, as described herein, is disclosed, wherein the means for deflation and inflation comprises fluid, e.g. hot fluid, injecting means, for example gas, e.g. steam and/or air, injecting means, for example pressurized fluid e.g. pressurized steam, pressurized gas and/or pressurized air, injecting means; fluid withdrawing means, e.g. a source for providing vacuum; and a deflatable and inflatable bladder.

In still further embodiments, in accordance with the present invention, a liner arrangement, as described herein, is disclosed, wherein the means for deflation and inflation comprises fluid, e.g. hot fluid, injecting means, for example, e.g. steam, gas and/or air, injecting means, for example pressurized gas e.g. pressurized steam, and/or pressurized air, injecting means; fluid withdrawing means, e.g. a source for providing vacuum; and said at least one liner part also functioning itself as a deflatable and inflatable bladder.

Further embodiments of the present invention disclose a liner arrangement, as described herein, wherein said enclosed part of the inserting hose is adapted with the gas, for example pressurized gas, e.g. steam and/or air, withdrawing and injecting means, and the deflatable and inflatable bladder is adapted mainly between said enclosing partitioning of the at least one liner part and said enclosed part of the inserting hose.

Even further embodiments of the present invention disclose a liner arrangement, as described herein, wherein the gas, for example pressurized gas, e.g. steam and/or air, withdrawing and injecting means, comprises, e.g., that the enclosed part of said inserting hose is adapted with, at least, one hole, for example, with several holes.

Still further embodiments of the present invention disclose a liner arrangement, as described herein, wherein the gas, for example pressurized gas, e.g. steam and/or air, withdrawing and injecting means, comprises, for example, one or more gas nozzles.

In a still further embodiment, in accordance with the present invention, a liner arrangement, as described herein, is disclosed, wherein the fastening means comprises, for example, glue, tape, band, e.g. rubber band, and/or clamps, e.g. glue, band and/or tape.

In an even further embodiment, in accordance with the present invention, a liner arrangement, as described herein, is disclosed, wherein the liner arrangement further comprises a tow rope.

In a further embodiment, in accordance with the present invention, a liner arrangement, as described herein, is disclosed, wherein the “for inserting” further also comprises “for installing” in a pipe structure, and wherein the said at least one liner part is adapted to be curable, e.g. is adapted with a curable composition, and wherein the liner arrangement further comprises a sealing arrangement.

The present invention does also relates to a method for relining a pipe structure involving:
providing a liner arrangement, as described herein,
inserting said liner arrangement into the interior of the pipe structure, wherein said liner arrangement, together with its fastening means, has an outer diameter that is smaller than the inner diameter of said pipe structure,
locating the at least one liner part at a desired position in the pipe structure,
inflating with the inflating function, of the means for deflation and inflation, wherein the means for deflation and inflation cooperates with the at least one liner part such that the at least one liner part conforms to the interior shape of the pipe structure, and
sealing the liner arrangement against the interior of the pipe structure, wherein said method comprises:
that during said insertion, the liner arrangement has ability to bend and

thereby demonstrating a minimum outside bend radius not greater than about the smallest inside bend radius of said pipe structure.

Each embodiment, as described herein, and features therein, may freely be combined with any of, or with several of, the other embodiments, of the liner arrangement, and/or of method for relining a pipe structure, all as described herein.

### BRIEF DESCRIPTION OF DRAWINGS

Aspects of the invention will be described in greater detail with reference to the embodiments that are shown in the drawings, in which

FIG. 1 illustrates a schematic view of a liner arrangement in accordance with the present invention,

FIG. 2 illustrates a schematic view of a liner arrangement, in accordance with the present invention, inserted in a pipe structure and on its way to a damage in a pipe structure,

FIG. 3 illustrates a schematic view of a liner arrangement, in accordance with the present invention, inserted in a pipe structure, and inside a boundary trap thereof, on its way to a damage in a pipe structure,

FIG. 4 illustrates a schematic view of a liner arrangement, in accordance with the present invention, inserted in a pipe structure, passing through a boundary trap on its way to a damage in a pipe structure,

FIG. 5 illustrates a schematic view of a liner arrangement, in accordance with the present invention, inserted in a pipe structure, having passed through a boundary trap, and situated in the vicinity of a damage in a pipe structure,

FIG. 6 illustrates a schematic view of a liner arrangement, in accordance with the present invention, inserted in a pipe structure, having passed through a boundary trap, and situated, and inflated, e.g. being installed, at a damage in a pipe structure,

FIG. 7 illustrates a schematic view of a section of a liner arrangement, in accordance with the present invention, inside a boundary trap.

### DETAILED DESCRIPTION

The embodiments of the present invention as described in the following are to be regarded only as examples and are in no way intended to limit the scope of the present invention.

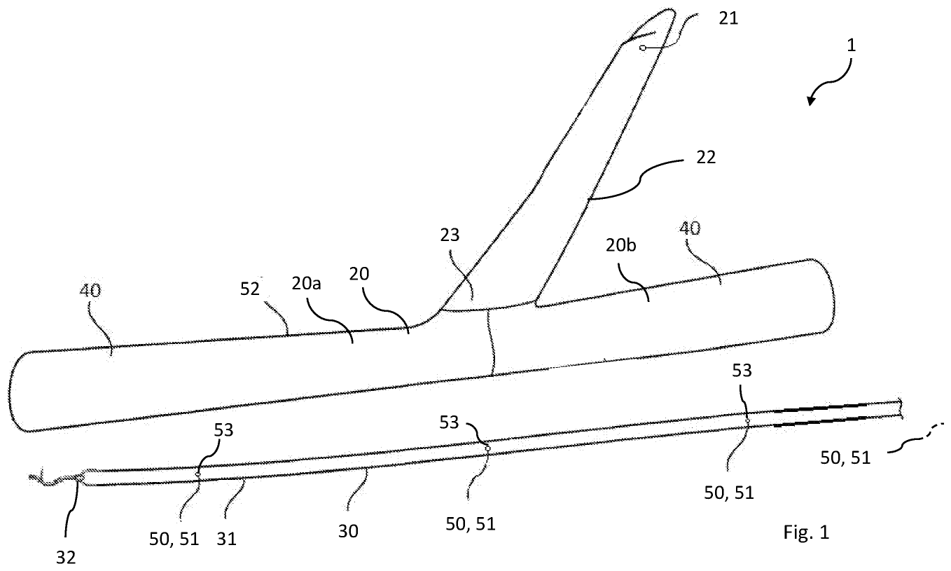

FIG. 1 illustrates a schematic view of an embodiment of a liner arrangement (1) for inserting in a pipe structure (not shown in FIG. 1), wherein the liner arrangement (1) comprises at least one liner part (20), an inserting tool (30) comprising an inserting hose (31), fastening means (40), and means for deflation and inflation (50). Further, here in FIG. 1, the at least one liner part (20) is itself comprised of two liner part departments (20a, 20b).

Furthermore in FIG. 1, the at least one liner part (20) and the second further liner part (22) define together a T-shape form (23). Further, the at least one liner part (20), i.e. the two liner part departments (20a, 20b), and the second further liner part (22), have all here each a general tube shape.

Further in FIG. 1, the second further liner part (22) is provided with a hole (21) for letting fluid, e.g. hot fluid, for example, oil, water or gas, e.g. steam and/or air, pass. Here in FIG. 1, the hole (21) is placed near the top of the second further liner part (22).

The liner arrangement (1), in FIG. 1, further comprises an inserting tool (30) comprising an inserting hose (31), and the inserting hose (31) is provided with holes (53) for letting fluid, e.g. hot fluid, pass, wherein the fluid, e.g. hot fluid, being for example, oil, water or gas, e.g. steam and/or air.

Here in FIG. 1, the at least one liner part (20) is separated from the inserting tool (30) and the inserting hose (31).

Furthermore, the inserting tool (30), i.e. the inserting hose (31), is adapted with fluid, e.g. hot fluid, injecting means (51), for example, oil, water or gas, e.g. steam and/or air, injecting means (51); fluid withdrawing means (51), e.g. a source for providing vacuum (51).

Moreover, the liner arrangement (1) comprises the means for deflation and inflation (50), wherein the means for deflation and inflation (50) comprises said fluid injecting, and withdrawing, means (51), and the inserting hose (31) provided with the holes (53). Said at least one liner part (20), and the second further liner part (22), may also function as a deflatable and inflatable bladder (52). Further, the dashed line to the right in FIG. 1, illustrates that the means for deflation and inflation (50), and the fluid injecting, and withdrawing, means (51), also comprises further components.

Further in FIG. 1, the at least one liner part (20) is illustrated with positions of fastening means (40). The fastening means (40) will help enabling fastening of the at least one liner part (20) to said inserting tool (30), and to said inserting hose (31).

Moreover, at the leading end of the inserting tool (30), and of the inserting hose (31), there is comprised a tow rope (32).

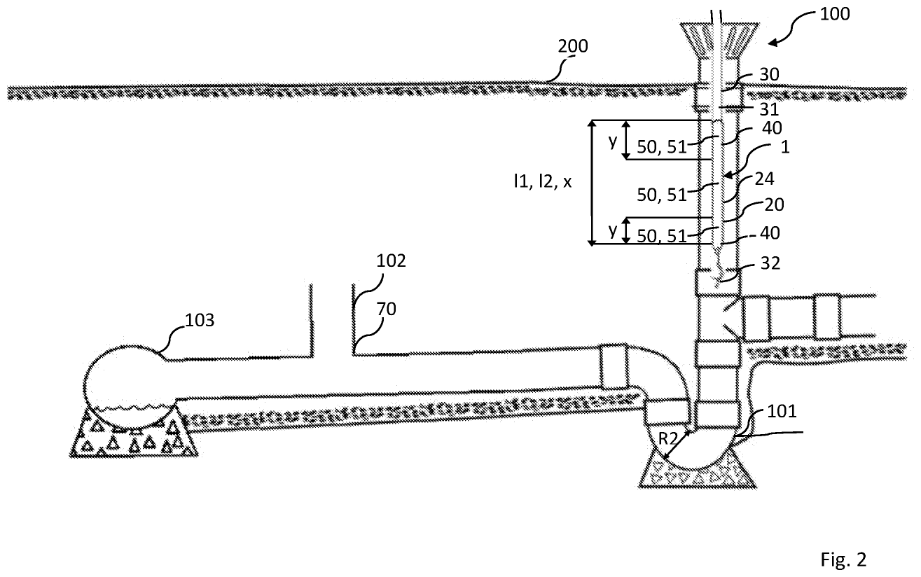

FIG. 2 illustrates a schematic view of an embodiment of a liner arrangement (1) where an insertion, from above the ground (200), of the liner arrangement (1) into a pipe structure (100) has started. Here the liner arrangement (1) is intended to be inserted, and installed, in a branch pipe (102), of the pipe structure (100), having a damage (70), wherein the damage (70) may be e.g. a crack or a wear out. A city main sewer (103), of the pipe structure (100), is also shown.

Furthermore in FIG. 2, the liner arrangement (1) comprises at least one liner part (20), an inserting tool (30) comprising an inserting hose (31), fastening means (40), means for deflation and inflation (50), and fluid injecting, and withdrawing, means (51).

Further, the at least one liner part (20) has a length (l1) and is adapted to cooperate with the means for deflation and inflation (50), wherein a partitioning (24) of said at least one liner part (20) encloses a part (x) of said inserting hose (31), and wherein the partitioning (24) has a length (l2).

Moreover, at least a fraction (y), here two fractions (y), of the enclosing partitioning (24), together with the fastening means (40), enable fastening of the at least one liner part (20) to said inserting hose (31) during insertion of the liner arrangement (1) in a pipe structure (100). The fastening means (40) may, for example, comprise glue, tape, band, e.g. rubber band, and/or clamps, e.g. glue, band and/or tape. Further, in FIG. 2 it is illustrated that the at least one liner part (20) is fastened to said inserting hose (31), and during said insertion.

At the leading end of the liner arrangement (1), here also at the leading end of the inserting hose (31), the liner arrangement (1) further comprises a tow rope (32).

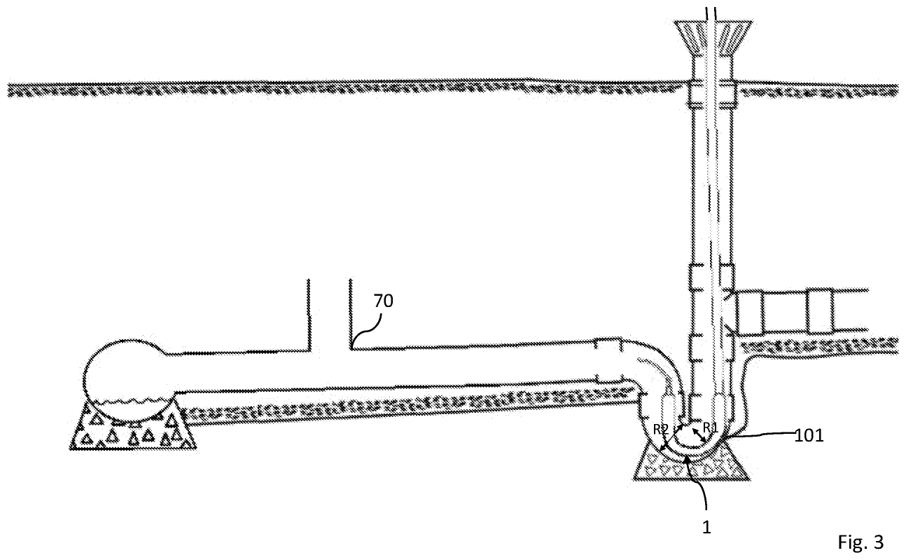

FIG. 3 illustrates a schematic view of an embodiment of the liner arrangement (1), wherein the liner arrangement (1) has travelled further in the pipe structure (100), on its way to the damage (70), and is now inside a pipe construction being a boundary trap (101). In FIG. 3 it is illustrated that the liner arrangement (1) has an outside bend radius (R1), and that the pipe construction, i.e. the boundary trap (101), has an inside bend radius (R2). Further, in FIG. 3, the liner arrangement (1) also demonstrates a minimum outside bend radius (R1) which are not greater than the smallest inside bend radius (R2) of the boundary trap (101).

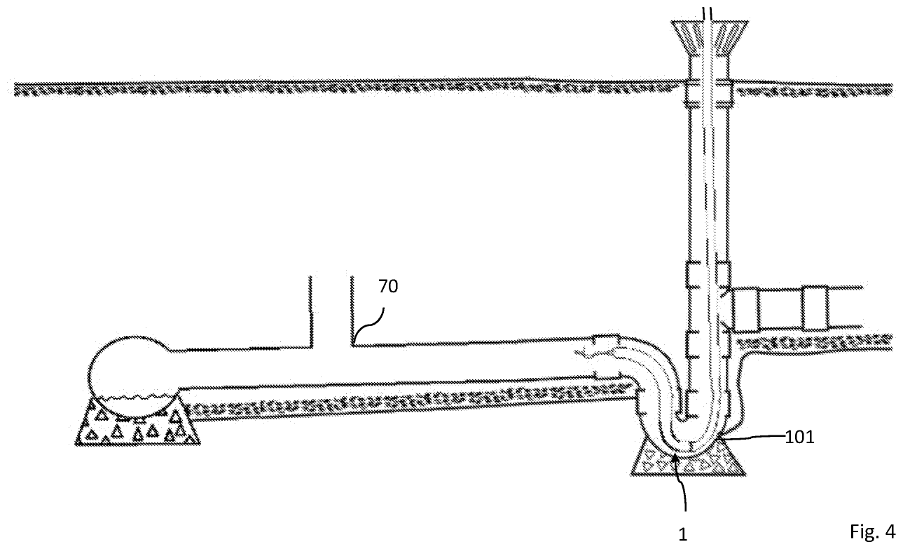

FIG. 4 illustrates a schematic view of an embodiment of the liner arrangement (1), wherein the liner arrangement (1) has travelled even further in the pipe structure (100), on its way to the damage (70), and is now almost completely outside the boundary trap (101).

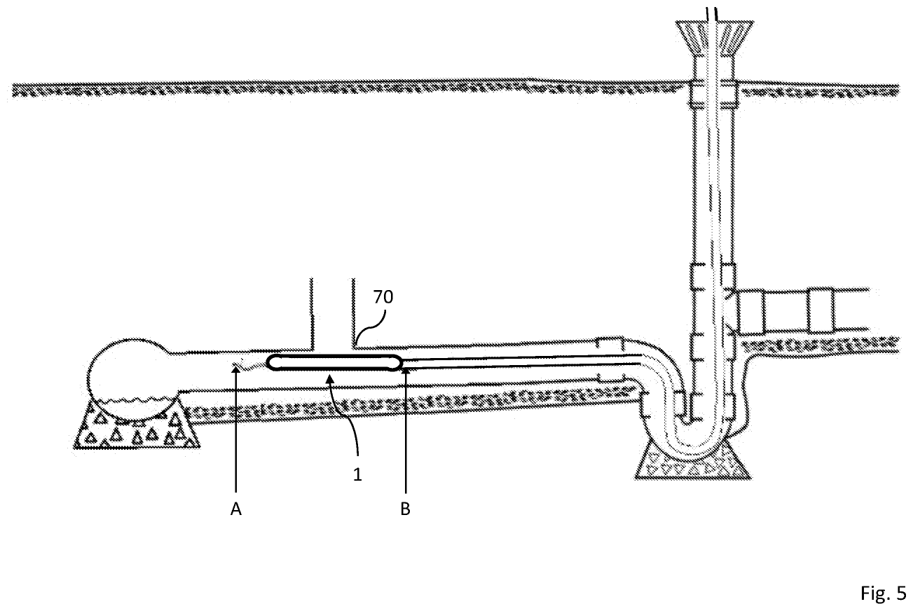

FIG. 5 illustrates a schematic view of an embodiment of the liner arrangement (1), wherein the liner arrangement (1) is inserted in the desired place for installation at the damage (70) in the pipe structure (100).

Further in FIG. 5, it is illustrated that the liner arrangement (1) is flexible over a length (from A to B) of the liner arrangement (1). The liner arrangement (1) also is able to demonstrate said minimum outside bend radius (R1), being not greater than the smallest inside bend radius (R2) of the boundary trap (101), over the length (from A to B) of the liner arrangement (1).

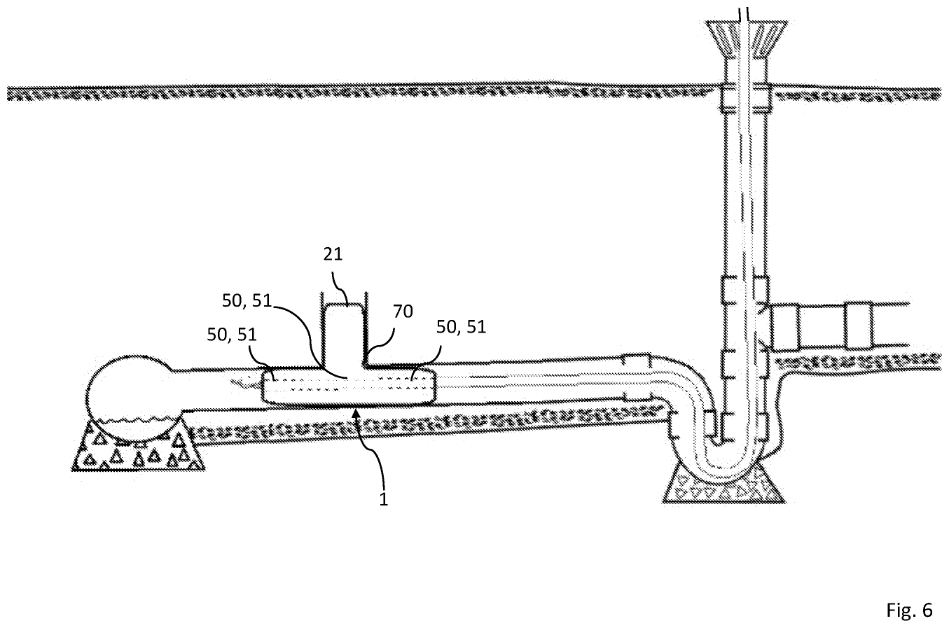

FIG. 6 illustrates a schematic view of an embodiment of the liner arrangement (1), wherein the liner arrangement (1) is inflated, and installed, in the desired place for installation at the damage (70). In FIG. 6, the means for deflation and inflation (50), the fluid injecting, and the withdrawing, means (51), and the inserting hose (partly shown as dotted inside the liner arrangement (1)), have cooperated with the liner parts such that the liner parts conform to the interior shape of the pipe structure at the damage (70). Further in FIG. 6, the hole (21) of a liner part of the liner arrangement (1) is illustrated.

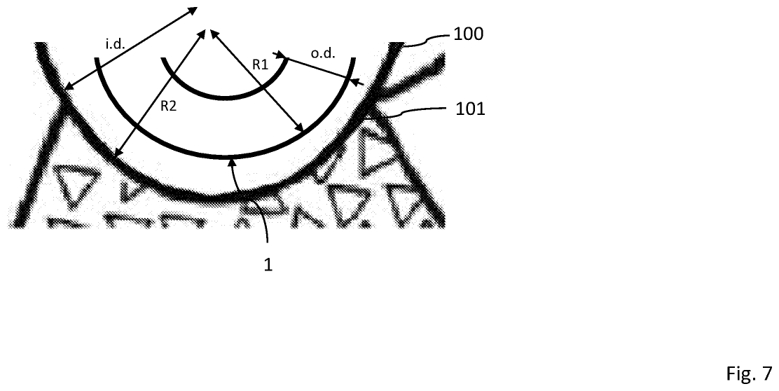

FIG. 7 illustrates a schematic view of a portion of the liner arrangement (1) and the boundary trap (101), wherein the liner arrangement (1) is inside the boundary trap (101). In FIG. 7 it is illustrated that the liner arrangement (1) has the outside bend radius (R1), and that the boundary trap (101) has the inside bend radius (R2). Further, in FIG. 7, the liner arrangement (1) also demonstrates a minimum outside bend radius (R1) which are not greater than the smallest inside bend radius (R2) of the boundary trap (101). Further, it is also illustrated here that said liner arrangement (1) has an outer diameter (o.d.) and that said pipe structure (100), here said boundary trap (101), has an inner diameter (i.d.).

Furthermore it is illustrated, that the liner arrangement (1) has an outer diameter (o.d.) being smaller than the inner diameter (i.d.) of said boundary trap (101).

According to aspects of this disclosure, the invention relates to improvements over prior art solutions. As mentioned initially, it is previously known to provide a liner arrangement comprising a flexible tube on which an inflatable bladder can be installed. According to prior art, such a flexible tube forms a tool which extends inside the inflatable bladder during operation, i.e. during use of the liner arrangement in a pipe. Furthermore, also according to prior art, the tool is normally slightly longer than the inflatable bladder and forms a separate tool which can be connected to a separate guide hose via a collar fitting, wherein said guide hose serves to force the tool with the bladder through the pipe. Also according to prior art, the tool can be disconnected from the guide hose by releasing the collar fitting. It can be contemplated that such a previously known tool can be used together with a plurality of guide hoses of different types and lengths.

According to aspects of this disclosure, and in contrast to prior art solutions, there is provided a solution which is not based on any tool of the above-mentioned type. A reason for this is that conventional collar fittings and similar connection devices are designed as rigid and non-flexible units which generally do not have the ability to bend in a manner which allows them to be pushed through a boundary trap 101 such as the one described above with reference to FIGS. 2-7. For this reason, prior art solutions with hard connection elements for connecting a tool based on a tube, as described above, cannot be used for inserting a liner arrangement into a pipe structure in a manner so that the entire liner arrangement, including a connection element for the tool, can be forced to pass through such a boundary trap.

As described above and with reference to the appended drawings, the present disclosure provides a solution to the drawbacks of the prior art and comprises a liner arrangement 1 which has ability to bend and thereby demonstrating a minimum outside bend radius (R1) not greater than about the smallest inside bend radius (R2) of said pipe structure 100. According to certain aspects, the liner arrangement 1 has the above-mentioned ability to bend along a length which is greater than the distance between an intended, final position 70 for the liner arrangement 1 along the pipe structure 100 and a position upstream of the location of said smallest inside bend radius (R2) of said pipe structure 100. According to an aspect, as shown in FIGS. 2-6, the liner arrangement 1 comprises an inserting tool 30 (see for example FIG. 1) which has the above-mentioned ability to bend along generally its entire length, i.e. at least a length which is greater than the distance between the expected position of the damage 70 (i.e. corresponding to the final position of the liner arrangement 1 and its liner parts 20, 22, as shown in FIG. 6) in the pipe structure and a position before (upstream of) the boundary trap 101.

According to further aspects, the inserting tool 30 comprises an inserting hose 31 which is formed without any connection elements or other stiff, hard or non-flexible elements (for example as described above with reference to prior art) which cannot pass through the curvature and bends of the boundary trap 101. Furthermore, according to further aspects, the inserting tool 30 is provided with suitable means for deflation and inflation 50, and suitably fluid injecting means 51, as described in detail above with reference to FIG. 1. Consequently, according to further aspects, the inserting tool 30 can be said to be integrated with the inserting hose 31 so as to allow the liner parts 20, 22 to be pushed through the pipe structure 100, including the boundary trap 101, so as to ultimately reach the position 70 of the damaged portion of the pipe structure 100. In such an embodiment, no stiff, hard or non-flexible elements, such as connection elements, are used to connect the inserting tool 30 to the inserting hose 31.

1. A liner arrangement for inserting in a pipe structure, wherein the liner arrangement comprises at least one liner part, an inserting tool comprising an inserting hose and means for deflation and inflation, and fastening means, wherein the at least one liner part has a length and is adapted to cooperate with the means for deflation and inflation, wherein
a partitioning of said at least one liner part encloses a part, of said inserting hose, and said partitioning has a length,
wherein at least a fraction of the enclosing partitioning, together with the fastening means, enable fastening of the at least one liner part to said inserting hose during insertion of the liner arrangement in a pipe structure, and wherein, while the at least one liner part is fastened to said inserting hose, and during said insertion, the liner arrangement has ability to bend and thereby demonstrating a minimum outside bend radius not greater than about the smallest inside bend radius of said pipe structure.

2. The liner arrangement according to claim 1, wherein the at least one liner part, during said insertion, cooperates with the means for deflation and inflation, and thereby the at least one liner part obtains an inflated state.

3. The liner arrangement according to claim 1, wherein the liner arrangement has ability to bend and thereby demonstrating a minimum outside bend radius not greater than about 97% of the smallest inside bend radius of said pipe structure.

4. The liner A-liner-arrangement according to claim 1, wherein said “at least a fraction” comprises one, two, three, four or more, fractions of the enclosing partitioning, and wherein the “at least a fraction”, the fastening means, and the deflation function, of the means for deflation and inflation, together enable fastening of the at least one liner part to said inserting hose during insertion of the liner arrangement in a pipe structure.

5. The liner arrangement according to claim 1, wherein the liner arrangement has ability to bend and ability to demonstrate said minimum outside bend radius, over, at least, a main stretch of the liner arrangement, wherein the main stretch stretches from the leading end of the liner arrangement, over, and past, the length of the at least one liner part, to an area on the inserting hose.

6. The liner arrangement according to claim 1, wherein the at least one liner part comprises a curable composition, the liner arrangement further comprises a sealing arrangement extending along the circumference of the at least one liner part, and the sealing arrangement is pre-mounted on at least one end section of the least one liner part before inserting the liner arrangement in said pipe structure.

7. The liner arrangement according to claim 1, wherein the means for deflation and inflation comprises fluid injecting means; fluid withdrawing means; and a deflatable and inflatable bladder, and/or said at least one liner part also functioning itself as a deflatable and inflatable bladder.

8. The liner arrangement according to claim 1, wherein the fastening means comprises at least one of glue, tape, and clamps.

9. The liner arrangement according to claim 1, wherein the liner arrangement further comprises a tow rope.

10. The liner arrangement according to claim 1, wherein the “for inserting” further also comprises “for installing” in a pipe structure, wherein the said at least one liner part is adapted to be curable, and wherein the liner arrangement further comprises a sealing arrangement.

11. The liner arrangement according to claim 1, wherein the liner arrangement has the above-mentioned ability to bend along a length which is greater than the distance between an intended position for the liner part along the pipe structure and a position upstream of the location of said smallest inside bend radius of said pipe structure.

12. The liner arrangement according to claim 11, wherein the liner arrangement comprises an inserting hose which is free from rigid and non-flexible elements along said length.

13. The liner arrangement according to claim 1, wherein the inserting tool is integrated with the inserting hose.

14. A method for relining a pipe structure involving:
providing a liner arrangement according to claim 1,
inserting said liner arrangement into the interior of the pipe structure, wherein said liner arrangement, together with said liner arrangement's its-fastening means, has an outer diameter that is smaller than the inner diameter of said pipe structure,
locating the at least one liner part at a desired position in the pipe structure,
inflating with the inflating function, of the means for deflation and inflation, wherein the means for deflation and inflation cooperates with the at least one liner part such that the at least one liner part conforms to the interior shape of the pipe structure, and
sealing the liner arrangement against the interior of the pipe structure wherein said method comprises:
that during said insertion, the liner arrangement has ability to bend and
thereby demonstrating a minimum outside bend radius not greater than about the smallest inside bend radius of said pipe structure.

15. The liner of claim 5, wherein the area on the inserting hose is in proximity to the at least one liner part.

16. The liner of claim 7, wherein the fluid injected by the fluid injecting means is one of hot oil, hot water, and hot gas, and wherein the fluid withdrawing means is a source for providing vacuum.

17. The liner arrangement according to claim 2, wherein the liner arrangement has ability to bend and thereby demonstrating a minimum outside bend radius not greater than about 97% of the smallest inside bend radius of said pipe structure.

18. The liner arrangement according to claim 2, wherein said “at least a fraction” comprises one, two, three, four or more, fractions of the enclosing partitioning, and wherein the “at least a fraction”, the fastening means, and the deflation function, of the means for deflation and inflation, together enable fastening of the at least one liner part to said inserting hose during insertion of the liner arrangement in a pipe structure.

19. The liner arrangement according to claim 3, wherein said “at least a fraction” comprises one, two, three, four or more, fractions of the enclosing partitioning, and wherein the “at least a fraction”, the fastening means, and the deflation function, of the means for deflation and inflation, together enable fastening of the at least one liner part to said inserting hose during insertion of the liner arrangement in a pipe structure.

20. The liner arrangement according to claim 2, wherein the liner arrangement has ability to bend and ability to demonstrate said minimum outside bend radius, over, at least, a main stretch of the liner arrangement, wherein the main stretch stretches from the leading end of the liner arrangement, over, and past, the length of the at least one liner part, to an area on the inserting hose.
